(19) United States
(12) Patent Application Publication
(10) Pub. No.: US 2017/0187864 A1
(43) Pub. Date: Jun. 29, 2017

(54) METHOD AND ELECTRONIC DEVICE FOR CONTROLLING EARPHONE KEYS

(71) Applicants: Le Holdings (Beijing) Co., Ltd., Beijing (CN); Lemobile Information Technology (Beijing) Co., Ltd., Beijing (CN)

(72) Inventor: Jianru Chen, Beijing (CN)

(73) Assignees: Le Holdings (Beijing) Co., Ltd., Beijing (CN); Lemobile Information Technology (Beijing) Co., Ltd., Beijing (CN)

(21) Appl. No.: 15/242,892

(22) Filed: Aug. 22, 2016

Related U.S. Application Data
(63) Continuation of application No. PCT/CN2016/088338, filed on Jul. 4, 2016.

(30) Foreign Application Priority Data
Dec. 23, 2015 (CN) 201510977816.4

(51) Int. Cl. H04M 1/725; H04W 76/06

(52) U.S. Cl. CPC H04M 1/72527; H04W 76/068; H04M 1/72569

(57) ABSTRACT

This disclosure discloses a method for controlling earphone keys and electronic device, where the method includes: detecting whether at least one key on an earphone is pressed or not; detecting the duration for which the at least one key is pressed down if the at least one key is pressed, determining that a first signal is received if the duration for which the at least one key is pressed down exceeds a first preset duration, or determining that a second signal is received if the duration for which the at least one key is pressed down is less than or equal to the first preset duration; acquiring a sequence of the first signal and the second signal received within a second preset duration; and performing a corresponding action according to the sequence.

### CROSS REFERENCE TO RELATED APPLICATIONS

This disclosure is a continuation of International Application No. PCT/CN2016/088338 filed on Jul. 4, 2016, which is based upon and claims priority to Chinese Patent Application No. 201510977816.4, filed on Dec. 23, 2015, titled “METHOD AND SYSTEM FOR CONTROLLING EARPHONE KEYS”, and the entire contents of which are incorporated herein by reference.

### TECHNICAL FIELD

This disclosure relates to the field of electronic control technologies, and specifically relates to a method for controlling earphone keys and electronic device.

### BACKGROUND

With the popularization of smart devices such as a smart phone, the smart devices have been used in all aspects of people's daily lives; however, sometimes there exists some situation in which it is not convenient to use the smart devices, for example, when a user enjoys music by a mobile phone connected to an earphone in a crowded carriage, and needs to view the current time or know about the weather conditions of the current day, but is not convenient to take out the mobile phone for viewing because the carriage is relatively crowded, and it is also possible to be targeted by thieves whereby, so that the user experience is not high. There is a need for a solution to obtain the current time or the weather conditions of the current day without taking out a mobile phone.

### SUMMARY

This disclosure provides a method for controlling earphone keys and electronic device, which can enable a mobile phone to perform anticipated actions without being taken out, so as to facilitate use by users and improve the user experience.

Thus, one objective of the embodiments of this disclosure is to provide a method for controlling earphone keys, including detecting whether at least one key on an earphone is pressed or not; detecting the duration for which the at least one key is pressed down if the at least one key is pressed, determining that a first signal is received if the duration for which the at least one key is pressed down exceeds a first preset duration, or determining that a second signal is received when the duration for which the at least one key is pressed down is less than or equal to the first preset duration; acquiring a sequence of the first signal and the second signal received within a second preset duration; and performing a corresponding action according to the sequence.

Another objective of the embodiments of this disclosure is to provide an electronic device including at least one processor and a memory in communication connection with the at least one processor, where the memory stores instructions that can be executed by the at least one processor, and the instructions are executed by the at least one processor to enable the at least one processor to: detect whether at least one key on an earphone is pressed or not; detect the duration for which the at least one key is pressed down if the at least one key is pressed, determine that a first signal is received if the duration for which the at least one key is pressed down exceeds a first preset duration, or determine that a second signal is received when the duration for which the at least one key is pressed down is less than or equal to the first preset duration; acquire a sequence of the first signal and the second signal received within a second preset duration; and perform a corresponding action according to the sequence.

Another objective of the embodiments of this disclosure is to provide a non-volatile computer storage medium storing computer executable instructions for: detecting whether at least one key on an earphone is pressed or not; detecting the duration for which the at least one key is pressed down if the at least one key is pressed, determining that a first signal is received if the duration for which the at least one key is pressed down exceeds a first preset duration, or determining that a second signal is received when the duration for which the at least one key is pressed down is less than or equal to the first preset duration; acquiring a sequence of the first signal and the second signal received within a second preset duration; and performing a corresponding action according to the sequence.

According to the method and electronic device for controlling earphone keys provided by the embodiments of this disclosure, a user may allow the mobile phone to perform a corresponding action by pressing a key in accordance with a preset combination of long press and short press, so that the mobile phone can perform an expected action without being taken out, for example voice broadcasting of the time, the weather conditions and the like, thereby facilitating the user's use and improving the user experience.

### BRIEF DESCRIPTION OF DRAWINGS

One or more embodiments are illustrated by way of example, and not by limitation, in the figures of the accompanying drawings, where elements having the same reference numeral designations represent like elements throughout. The drawings are not to scale, unless otherwise disclosed.

FIG. 1 shows a flow chart of a method for controlling earphone keys according to the embodiments of this disclosure;

FIG. 2 shows a specific example of the method for controlling earphone keys in FIG. 1;

FIG. 3 shows a schematic diagram of a system for controlling earphone keys according to the embodiments of this disclosure;

FIG. 4 shows a schematic diagram of a hardware structure of an electronic device for executing the method for controlling earphone keys according to the embodiments of this disclosure.

### DETAILED DESCRIPTION

To make the objectives, the technical scheme and the advantages of the embodiments of this disclosure clearer, the technical scheme of this disclosure will be clearly and completely described hereinafter through implementation with reference to the accompanying drawings in the embodiments of this disclosure. Apparently, the embodiments described below are a part, instead of all, of the embodiments of this disclosure.

### Embodiment 1

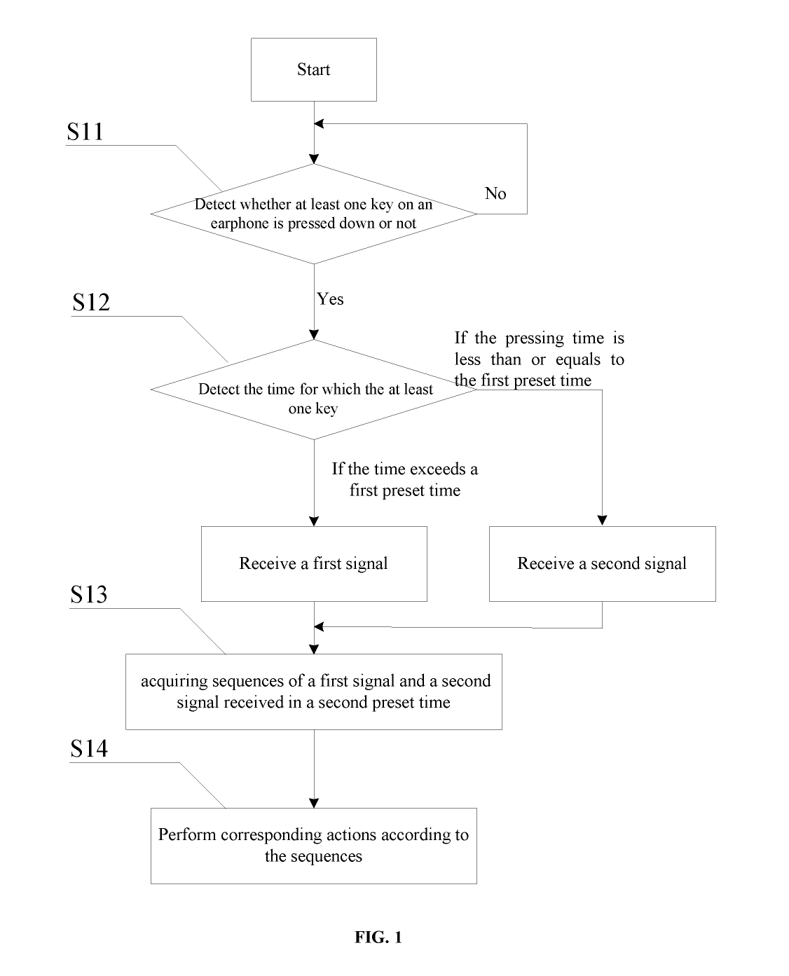

The embodiment of this disclosure provides a method for controlling earphone keys, the method is used for controlling smart devices such as a smart phone, etc., and as shown in FIG. 1, the method includes the following steps:

S11: detecting whether at least one key on an earphone is pressed or not; if the at least one key is pressed, performing step S12; and if no key is pressed, returning to step S11 to continue detection. Usually, whether the dialing/answering key on the earphone is pressed or not may be detected it, and an earphone with other keys can be set to detect whether the other keys as are pressed or not.

S12: detecting the duration for which the at least one key is pressed down; if the duration for which the at least key is pressed down exceeds a first preset duration, it may be considered that the key is long pressed, namely it is determined that a first signal is received; or if the duration for which the at least one key is pressed down is less than or equal to a first preset duration, it may be considered that the key is short pressed, namely it is determined that a second signal is received. The first preset duration may be set in advance, for example, it may be set as 0.5 s, that is to say, the pressing down for 0.5 s or more is considered as a long press; and pressing down for less than 5 s is considered as a short press. Of course, the first preset duration may also be freely set by a user according to the operating habits of the user.

S13: acquiring a sequence of the first signal and the second signal received within a second preset duration. The second preset duration may be set in advance, for example, it may be set as 5 s, namely recording a sequence of long press and short press within 5 s; likewise, the second preset duration may also be set freely by a user according to the operating habits of the user. A key press operation instruction sent by the user should be completed within the second preset duration, and after the duration for which the user operates the keys exceeds the second preset duration, it is considered as that the user sends out a next instruction.

S14: performing a corresponding action according to the sequence. The action corresponding to the sequence may be set in advance or set by the user freely. For example, when one long press and then one short press are recorded within the second preset duration, the current time can be reported by voice, and thus the user does not need to take up the mobile phone but hears the current time directly through the earphone. For another example, when one short press and then one long press are recorded within the second preset duration, the weather can be reported by voice. Of course, according to the embodiments of this disclosure, the actions are not only limited to voice broadcasting of time or voice broadcasting of weather, and the user may set more combinations of long press and short press as needed to implement more functions.

By the method for controlling earphone keys provided by the embodiments of this disclosure, a user may enable a mobile phone to perform a corresponding action by simply pressing a key on an earphone in accordance with a preset combination of long press and short press, so that the mobile phone can perform an expected action without being taken out, such as voice broadcasting of the current time, weather condition, and the like, thereby facilitating user's use and improving the user's experience.

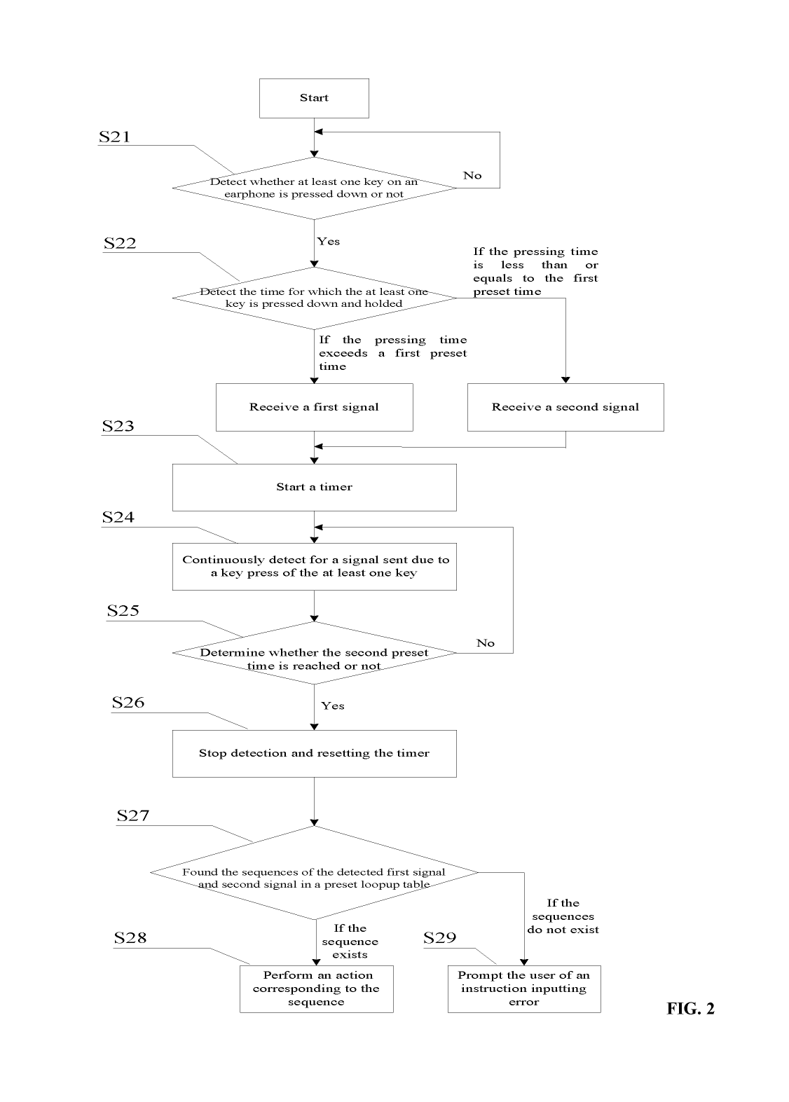

FIG. 2 shows a specific example of the method for controlling earphone keys in FIG. 1, and as shown in FIG. 2, the method includes the following steps:

S21: detecting whether at least one key on an earphone is pressed or not; if the at least one key is pressed, performing step S22; and if no key is pressed, returning to step S21 to continue detection.

S22: detecting the duration for which the at least one key is pressed down; if the duration for which the key is pressed down exceeds a first preset duration, it is determined that a first signal is received; and if the duration for which the at least one key is pressed down is less than or equal to the first preset duration, it is determined that a second signal is received. Likewise, the first preset duration may be set in advance, and may also be freely set by a user according to the operating habits of the user.

S23: starting a timer. The timer may be started immediately when it is detected that the key is pressed down, so as to start time counting.

S24: continuing detection for the signal sent when the at least one key is pressed down. In the time counting process of the timer, whether a key is pressed down is continuously detected. When any key is pressed down, whether the press is a long press or a short press is recorded, namely recording whether the sent signal is a first signal or a second signal.

S25: judging whether a second preset duration is reached; if the second preset duration is not reached, returning to step S24 to continue the step of detecting and recording; if the second preset duration is reached, performing step S26. Likewise, the second preset duration may be set in advance, and may also be set freely by a user according to the operating habits of the user.

S26: stopping the step of detecting the signal sent when the at least one key is pressed, and resetting the timer. A key operating instruction sent by the user should be completed within the second preset duration, and after the duration for which the user operates a key exceeds the second preset duration, it is considered as that the user sends a next instruction.

S27: searching a sequence of the detected first and second signals in a preset lookup table; if the sequence exists in the lookup table, performing step S28; and if the sequence does not exist in the lookup table, performing step S29.

S28: performing an action corresponding to the sequence.

S29: prompting the user of an instruction input error. As a preferred implementation, after a user is prompted of the instruction input error, the method further includes the following steps: prompting the user to set new actions for the sequence, and storing the sequence and the associated new actions in the lookup table when the new actions set by the user is received, so that when the user inputs the sequence next time, the smart device is enabled to perform the new actions.

By means of the method for controlling earphone keys provided by the embodiments of this disclosure, a user may enable a mobile phone to perform a corresponding action by simply pressing a key on an earphone in accordance with a preset combination of long press and short press, so that the mobile phone can perform an expected action without being taken out, such as voice broadcasting of the current time, the weather condition and the like, thereby facilitating user's use and improving the user experience. Meanwhile, in this embodiment, a timer is used to distinguish a division point between last and next instructions, which is simple and easy to implement; and by storing a sequence of first and second signals and an associated corresponding action in the lookup table, a smart device can quickly take an action corresponding to an instruction sent by a user, and the actions are easy to be modified, increased or deleted.

### Embodiment 2

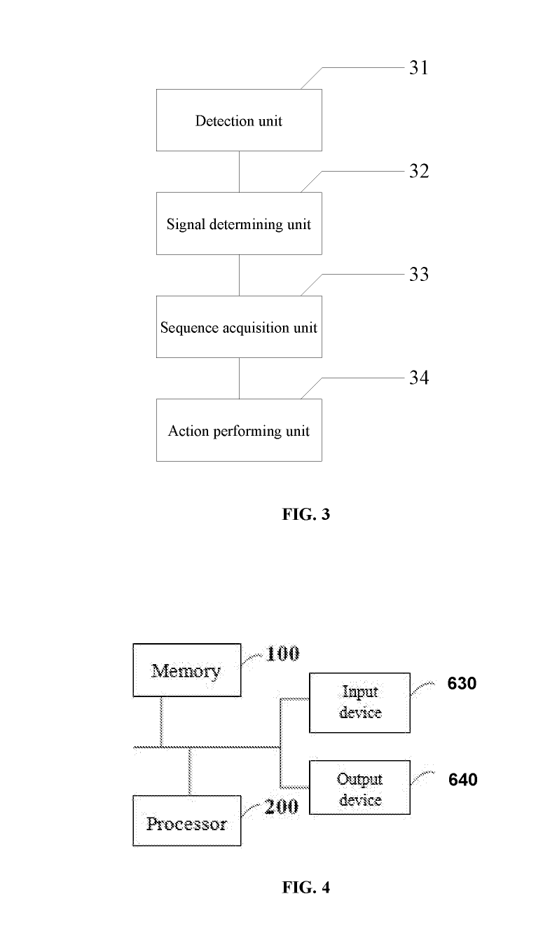

The embodiment of this disclosure further provides a system for controlling earphone keys, the system is used for controlling smart devices such as a smart phone, and as shown in FIG. 3, the system includes the following units: a detection unit 31, for detecting whether at least one key on an earphone is pressed or not; a signal determining unit 32, for detecting the duration for which the at least one key is pressed down when the at least one key is pressed, if the duration for which the at least one key is pressed down exceeds a first preset duration, determining that a first signal is received; or if the duration for which the at least one key is pressed down is less than or equal to the first preset duration, determining that a second signal is received; a sequence acquisition unit 33, for acquiring a sequence of the first signal and the second signal received within a second preset duration; and an action execution unit 34, for executing a corresponding action according to the sequence.

By means of the system for controlling earphone keys provided by the embodiments of this disclosure, a user may enable a mobile phone to perform a corresponding action by simply pressing a key on an earphone in accordance with a preset combination of long press and short press, so that the mobile phone can execute an expected action without being taken out, such as voice broadcasting the current time, the weather condition and the like, thereby facilitating user's use and improving the user experience.

As a preferred implementation, the action execution unit 34 may include the following subunits: a searching subunit, for searching the sequence in a preset lookup table which includes multiple sequences and actions associated with each of the multiple sequences; a first execution subunit, for executing an action corresponding to the sequence when the sequence exists in the lookup table; and a second execution subunit, for prompting a user of an instruction input error and prompting the user to set a new action for the sequence when the sequence does not exist in the lookup table, and storing the sequence and the associated new actions in the lookup table when the new action set by the user is received.

The action execution unit 34 in this embodiment stores a sequence of the first and second signals and an associated corresponding action in the lookup table, so that a smart device is enabled to quickly take an action corresponding to an instruction sent by a user, and the actions are easy to be modified, increased and deleted. Moreover, when a user inputs a sequence which does not exist in the lookup table, the user may be prompted to set a new action for the sequence, so that when the user inputs the sequence next time, the smart device is enabled to perform the new action.

As a preferred implementation, the above-described actions include, but are not limited to, voice broadcasting of time and voice broadcasting of weather, and a user can freely set more combinations of long press and short press as needed to implement more functions.

As a preferred implementation, the sequence acquisition unit 33 may include a starting subunit for starting a timer; a detection subunit for detecting a signal sent when the at least one key is pressed; and a determining subunit for determining whether the second preset duration is reached or not, if the second preset duration is not reached, continuing the step of detecting and recording the signal sent when the at least one key is pressed; or if the second preset duration is reached, stopping the step of detecting a signal sent when the at least one key is pressed and resetting the timer.

The sequence acquisition unit 33 in the present embodiment uses the timer to distinguish the division point between last and next instructions, which is simple and easy to implement.

### Embodiment 3

The embodiment of this disclosure provides a non-volatile computer storage medium storing computer executable instructions than can be used for executing the method for controlling earphone keys in any one of the abovementioned embodiments of the method.

### Embodiment 4

FIG. 4 is a schematic diagram of a hardware structure of the electronic device for executing the method for controlling earphone keys in the embodiment of this disclosure, and as shown in FIG. 4, the device includes one or more processors 200 and a memory 100, and one processor 200 is taken as an example in FIG. 4; and the electronic device for executing the method for controlling earphone keys may also include an input device 630 and an output device 640.

The processor 200, the memory 100, the input device 630 and the output device 640 may be connected with a bus or in other ways, and bus connection is taken as an example in FIG. 4.

The memory 100, as a non-volatile computer readable storage medium, may be used for storing non-volatile software programs, non-volatile computer executable programs and modules, for example, program instructions/modules (e.g., a detection unit 31, a signal determining unit 32, a sequence acquisition unit 33, and an action execution unit 34 shown in FIG. 3) corresponding to the method for controlling earphone keys in the embodiments of this disclosure. The processor 200 runs the non-volatile software programs, instructions and modules stored in the memory 100 so as to execute various functional disclosures and data processing of a server, thereby implementing the method for controlling earphone keys in the abovementioned embodiments of the method.

The memory 100 may include a program storage area and a data storage area, where the program storage area may store an operating system and disclosures for at least one functions; and the data storage area may store data and the like created according to the use of the device for controlling earphone keys. Moreover, the memory 100 may include a high-speed random access memory, and may also include a non-volatile memory, for example, at least one disk storage device, a flash memory, or other non-volatile solid storage devices. In some embodiments, the memory 100 optionally includes memories that are set remotely relative to the processor 200, and these remote memories may be connected to the device for controlling earphone keys through a network. An example of the network includes, but is not limited to, internet, intranet, LAN, mobile communication network, and the combinations thereof

The input device 630 may receive input digit or character information, and generates a key signal input related to the user configuration and function control of the device for controlling earphone keys. The output device 640 may include display devices such as a display screen.

The one or more modules are stored in the memory 100, and when executed by the one or more processors 200, perform the method for controlling earphone keys in any one of the abovementioned embodiments of the method.

The abovementioned product can perform the method provided by the embodiments of this disclosure and has corresponding functional modules and beneficial effects for executing the method. For those technical details that are not described in this embodiment in detail, please refer to the method provided by the embodiments of this disclosure.

The electronic device of the embodiments of this disclosure exists in many forms, including but not limited to the following devices:

(1) Mobile communication devices: the characteristic of such devices is that they have a mobile communication function with a main goal of enabling voice and data communication. Such terminals include: smart phones (such as iPhone), multimedia phones, feature phones, low-end phones, etc.

(2) Ultra-mobile personal computer devices: such devices belong to the category of personal computers, have computing and processing functions, and usually also have mobile internet access features. Such terminals include: PDA, MID, UMPC devices, etc., such as iPad.

(3) Portable entertainment devices: such devices are able to display and play multimedia contents. Such devices include: audio and video players (such as iPod), handheld game players, electronic books, intelligent toys, and portable vehicle navigation devices.

(4) Servers: devices providing computing services. The structure of a server includes a processor, a hard disk, an internal memory, a system bus, etc. A server has architecture similar to that of a general purpose computer, but in order to provide highly reliable services, the server has higher requirements in aspects of processing capability, stability, reliability, security, expandability, manageability, etc.

(5) Other electronic devices having data interaction function.

The abovementioned device embodiments are only illustrative, where the units described as separate parts may be or may not be physically separated, the components shown as units may be or may not be physical units, i.e. may be located in one place, or may be distributed at multiple network units. According to actual requirements, part of or all of the modules may be selected to realize the objectives of the technical scheme of the embodiment.

By abovementioned descriptions of the implementations, those skilled in the art can clearly understand that various implementations may be implemented by software and a general hardware platform, and of course, may also be implemented by hardware. Based on such understanding, the abovementioned technical scheme in essence, or the part thereof making a contribution to a related technology, may be embodied in the form of a software product, and such computer software product may be stored in a computer readable storage medium such as an ROM/RAM, a magnetic disk or an optical disk, etc., and may include a number of instructions to enable a computer device (which may be a personal computer, a server, or a network device, etc.) to execute the methods described in the various embodiments or in some parts thereof.

Finally, it should be noted that: the abovementioned embodiments are merely illustrated for describing rather than limiting the technical scheme of this disclosure; although detailed description of this disclosure is given with reference to the abovementioned embodiments, those skilled in the art should understand that they still can modify the technical scheme recorded in the abovementioned various embodiments or replace part of the technical features therein with equivalents; and these modifications or replacements would not cause the essence of the corresponding technical scheme to depart from the spirit and scope of the technical scheme of the various embodiments of this disclosure.

What is claimed is:

1. A method for controlling earphone keys, comprising:
detecting whether at least one key on an earphone is pressed or not;
detecting the duration for which the at least one key is pressed down if the at least one key is pressed, determining that a first signal is received if the duration for which the at least one key is pressed down exceeds a first preset duration, or determining that a second signal is received when the duration for which the at least one key is pressed down is less than or equal to the first preset duration;
acquiring a sequence of the first signal and the second signal received within a second preset duration; and
performing a corresponding action according to the sequence.

2. The method according to claim 1, wherein the step of performing the corresponding operation according to the sequence comprises:
searching the sequence in a preset lookup table which comprises multiple sequences and actions associated with each of the multiple sequences; and
performing an action corresponding to the sequence if the sequence exists in the lookup table.

3. The method according to claim 2, wherein the step of performing the corresponding operation according to the sequence further comprises:
prompting a user of an instruction input error and prompting the user to set a new action for the sequence if the sequence does not exist in the lookup table, and storing the sequence and the associated new action in the lookup table if the new action set by the user is received.

4. The method according to claim 1, wherein the actions comprise voice broadcasting of time and voice broadcasting of weather.

5. The method according to claim 1, wherein the step of acquiring a sequence of the first signal and the second signal received within a second preset duration comprises:
starting a timer;
detecting a signal sent when the at least one key is pressed; and
determining whether the second preset duration is reached; if the second preset duration is not reached, continuing the step of detecting and recording the signal sent when the at least one key is pressed; or if the second preset duration is reached, stopping the step of detecting a signal sent when the at least one key is pressed and resetting the timer.

6. An electronic device, comprising:
at least one processor, and a memory in communication connection with the at least one processor, wherein the memory stores instructions that can be executed by the at least one processor, and the instructions are executed by the at least one processor to enable the at least one processor to:
detect whether at least one key on an earphone is pressed or not;
detect the duration for which the at least one key is pressed down if the at least one key is pressed, determine that a first signal is received if the duration for which the at least one key is pressed down exceeds a first preset duration, or determine that a second signal is received when the duration for which the at least one key is pressed down is less than or equal to the first preset duration;
acquire a sequence of the first signal and the second signal received within a second preset duration; and
perform a corresponding action according to the sequence.

7. The electronic device according to claim 6, wherein the step of performing a corresponding action according to the sequence comprises:
searching the sequence in a preset lookup table which comprises multiple sequences and actions associated with each of the multiple sequences; and
performing an action corresponding to the sequence if the sequence exists in the lookup table.

8. The electronic device according to claim 7, wherein the step of performing a corresponding operation according to the sequence comprises:
prompting a user of an instruction input error and prompting the user to set a new action for the sequence if the sequence does not exist in the lookup table, and storing the sequence and the associated new action in the lookup table if the new action set by the user is received.

9. The electronic device according to claim 6, wherein the actions comprise voice broadcasting of time and voice broadcasting of weather.

10. The electronic device according to claim 6, wherein the step of acquiring the sequence of the first signal and the second signal received within the second preset duration comprises:
starting a timer;
detecting a signal sent when the at least one key is pressed; and
determining whether the second preset duration is reached or not; if the second preset duration is not reached, continuing the step of detecting and recording the signal sent when the at least one key is pressed; or if the second preset duration is reached, stopping the step of detecting a signal sent when the at least one key is pressed and resetting the timer.

11. A non-volatile computer storage medium, storing computer executable instructions for:
detecting whether at least one key on an earphone is pressed or not;
detecting the duration for which the at least one key is pressed down if the at least one key is pressed, determining that a first signal is received if the duration for which the at least one key is pressed down exceeds a first preset duration, or determining that a second signal is received when the duration for which the at least one key is pressed down is less than or equal to the first preset duration;
acquiring a sequence of the first signal and the second signal received within a second preset duration; and
performing a corresponding action according to the sequence.

12. The non-volatile computer storage medium according to claim 11, wherein the step of performing the corresponding operation according to the sequence comprises: searching the sequence in a preset lookup table which comprises multiple sequences and actions associated with each of the multiple sequences; and performing an action corresponding to the sequence if the sequence exists in the lookup table.

13. The non-volatile computer storage medium according to claim 12, wherein the step of performing the corresponding operation according to the sequence further comprises: prompting a user of an instruction input error and prompting the user to set a new action for the sequence if the sequence does not exist in the lookup table, and storing the sequence and the associated new action in the lookup table if the new action set by the user is received.

14. The non-volatile computer storage medium according to claim 11, wherein the actions comprise voice broadcasting of time and voice broadcasting of weather.

15. The non-volatile computer storage medium according to claim 11, wherein the step of acquiring a sequence of the first signal and the second signal received within a second preset duration comprises:
starting a timer;
detecting a signal sent when the at least one key is pressed; and
determining whether the second preset duration is reached or not; if the second preset duration is not reached, continuing the step of detecting and recording the signal sent when the at least one key is pressed; or if the second preset duration is reached, stopping the step of detecting a signal sent when the at least one key is pressed and resetting the timer.
